(19) United States
(12) Patent Application Publication
(10) Pub. No.: US 2022/0300293 A1
(43) Pub. Date: Sep. 22, 2022

(54) RISK QUANTIFICATION SYSTEM

(71) Applicant: Goodlifers, LLC, Moosic, PA (US)

(72) Inventors: Thomas P. BOLES, Clarks Summit, PA (US); Christopher L. ROTHWELL, South Abington Township, PA (US)

(21) Appl. No.: 17/832,494

(22) Filed: Jun. 3, 2022

Related U.S. Application Data
(63) Continuation-in-part of application No. 16/711,219, filed on Dec. 11, 2019.
Application No. 16/711,219 is a continuation-in-part of application No. 16/010,382, filed on Jun. 15, 2018, now abandoned.
Application No. 16/010,382 is a division of application No. 14/799,459, filed on Jul. 14, 2015, now abandoned.
(60) Provisional application No. 63/196,479, filed on Jun. 3, 2021.
(60) Provisional application No. 62/024,816, filed on Jul. 15, 2014.

(51) Int. Cl. G06F 9/4401; G06F 9/455; G06F 9/50; G06Q 30/00

(52) U.S. Cl. CPC G06F 9/4408; G06F 9/4416; G06F 9/45558; G06F 9/4401; G06F 9/45533; G06F 9/5061; G06Q 30/018; G06F 2009/45575

(57) ABSTRACT

A system that quantifies the risk of harm or loss posed by an employer by storing employee screening procedures and, for each of a plurality of industries, an industry-specific weight indicative of a relative importance of performing the employee screening procedure to reduce the risk of harm or loss posed by an organization in the industry, providing functionality for the employer to specify the employee screening procedures performed by the employer, receiving verification documents from the employer verifying that the employer performs the employee screening procedures specified by the employer, identifying the industry of the employer, and quantifying the risk of harm or loss posed by the employer by summing each of the industry-specific weights, for the industry of the employer, of the employee screening procedures performed by the employer.

### CROSS-REFERENCE TO RELATED APPLICATIONS

This application is a continuation-in-part of U.S. patent application Ser. No. 16/711,219, filed Dec. 11, 2019, and claims priority to U.S. Prov. Pat. Appl. No. 63/196,479, filed Jun. 3, 2021, both of which are hereby incorporated by reference in their entirety.

### BACKGROUND

Particularly in certain industries, businesses can dramatically reduce their risk of causing personal harm—and experiencing financial loss—by making a concerted effort to screen potential new employees. In the home health industry, to use just one example, organizations hire numerous home health aides to provide in-home health services. Thoroughly screening home health aides before they provide unsupervised services in the homes of vulnerable patients increases the likelihood that new employees will provide the expected standard of care and reduces the likelihood that the home health company will be liable for a loss arising from the actions of those home health aides.

There are numerous employee screening procedures that are commonly performed by employers across industries. However, because each industry has its own unique set of potential risks and its own unique opportunities and standards for providing quality service, the relative effectiveness of each employee screening procedure to reduce the risk of future harm or loss will vary from industry to industry. Therefore, in many industries, a consensus has emerged as to the “best practices” for screening potential employees—and the relative effectiveness of each employee screening procedure—to reduce the risk of harm caused by an organization in that industry and the risk of future loss to an organization in that specific industry.

Governmental agencies (e.g., county health departments, school districts, etc.) often contract with private organizations (e.g., nursing homes, home health organizations, transportation companies, etc.) to provide services and/or refer those organizations to residents. Ideally, before referring or hiring an organization, the agency determines whether that organization provides quality services or if that organization will put residents at risk of harm. Additionally, individuals deciding whether to contract with an organization may also wish to know whether that organization will put them or their family members at risk of harm. Meanwhile, to provide insurance to organizations, insurers need to assess the risk that each individual business will suffer a loss in the future.

Individual consumers often have very little information upon which to assess whether an organization will put them or their family member at risk of harm. Over time, individuals at governmental agencies may form subjective opinions that certain organizations put residents at risk. However, those opinions may be speculative, inaccurate, and formed only after the organization has negligently exposed others to harm.

Insurers typically utilize underwriters who gather information from those organizations and subjectively assess each organization's risk of future loss. However, using human underwriters to gather information from an organization and subjectively assessing that organization's future risk has a number of drawbacks. Relying on any subjective assessment of risk invites the possibility of underassessing that risk, which creates a risk for the insurer, or over-assessing that risk, which could result in either the employer paying more for insurance than would otherwise be necessary or the insurer losing a customer to another insurer willing to insure the organization at a lower cost. Employing human underwriters to gather information is also time consuming and costly. Additionally, even if an underwriter tries to identify the employee screening procedures used by the employer. the underwriter may come away with an inaccurate understanding of the employee screening procedures the employer actually performs. Whether the employer was not being completely truthful or the underwriter simply misunderstood the information provided, insurers may not have an adequate remedy if they rely on an underwriter for information and, as a consequence, underassess the employer's risk of future loss. Finally, the employee screening procedures performed by the employer may change over time and, by extension, their risk of future loss may be dynamic. By relying on a single assessment (or infrequent assessments) from an underwriter, insurers may underassess the risk posed by an employer who stops performing employee screening procedures over time. By the same token, an employer who adopts additional employee screening procedures may pay higher premiums than is necessary because of an outdated, overassessment of their risk of loss.

Accordingly, there is a need for an objective, rules-based quantification of the risk of harm and future loss posed by employers. Additionally, there is a need for a platform enabling assessors (e.g., insurers, government agencies, individuals, etc.) to gather reliable information identifying the employee screening procedures performed by an employer directly from the employer. Preferably, the platform would incentivize employers to provide the information, to be truthful, and to continue performing those employee screening procedures in the future. Even more preferably, the platform would also enable an insurer to seek a remedy in the event that the employer does not perform the identified employee screening procedures and suffers a loss. Finally, there is a need for a technological solution enabling assessors to more accurately quantify the dynamic risk of harm and loss posed by each employer as their procedures shift over time.

### SUMMARY

The disclosed system provides a platform to identify the employee screening procedures performed by an employer and, in view of those identified procedures, quantifies the future risk of harm and loss posed by the employer using an objective, rules-based process. To quantify the risk of harm, the system uses specific rules derived from literature articulating the best practices in each of a number of industries and the relative effectiveness of each employee screening procedure to reduce the risk of harm or loss posed by an organization in that industry.

The system provides functionality for employers to identify the employee screening procedures they perform directly, reducing the time and expense required for assessors to gather that information. Additionally, the system enables employers to provide documentation verifying that those employee screening procedures are being performed, allowing an assessor to efficiently verify the information provided by the employer.

Because screening employees reduces their risk of future loss and, by extension, the cost of their insurance and the likelihood of contracting with government agencies and individual consumers, employers may be incentivized to identify all of the employee screening procedures they perform (and in some instances may even be incentivized to perform additional employee screening procedures to further reduce their risk of harm or loss). In the event that the employer fails to perform the identified employee screening procedures and suffers a loss, the system enables an insurer to seek remedies that may not have been previously available to the insurer because the system receives that information from the insured organization (and an attestation that the information is correct) rather than relying on an underwriter of the insurer. For instance, the insurer may retain the right to deny coverage for any loss arising from the action of an employee that was not first screened using the employee screening procedures identified by the employer.

Finally, by date stamping the information received from the employer, the system provides functionality for the insurer to ensure that the information received from the employer is timely. Meanwhile, the system provides a platform to contact the employer and functionality for the employer to revise the information they provided as necessary and re-attest that the information provided is accurate and current.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram of an architecture of a risk quantification system according to an exemplary embodiment.

FIG. 2A is a block diagram illustrating the risk quantification system according to an exemplary embodiment.

FIG. 2B illustrates the employee screening procedures and industry-specific weights stored by the risk quantification system according to an exemplary embodiment.

FIG. 3 is a risk quantification request view (of an assessor graphical user interface or an employer graphical user interface) according to an exemplary embodiment.

FIG. 4 is an employer contact information view of the assessor user interface according to an exemplary embodiment.

FIG. 5 is a welcome view of the employer graphical user interface according to an exemplary embodiment.

FIG. 6 is a contact information view of the employer graphical user interface according to an exemplary embodiment.

FIG. 7A is an assessment view of the employer graphical user interface according to an exemplary embodiment.

FIG. 7B is another assessment view of the employer graphical user interface according to an exemplary embodiment.

FIG. 7C is another assessment view of the employer graphical user interface according to an exemplary embodiment.

FIG. 7D is another assessment view of the employer graphical user interface according to an exemplary embodiment.

FIG. 8 is an attestation view of the employer graphical user interface according to an exemplary embodiment.

FIG. 9 is an example report quantifying the risk of harm or loss posed by an employer according to an exemplary embodiment.

FIG. 10A is an employee screening procedure verification view the employer graphical user interface according to an exemplary embodiment.

FIG. 10B is another employee screening procedure verification view the employer graphical user interface according to an exemplary embodiment.

FIG. 10C is another employee screening procedure verification view the employer graphical user interface according to an exemplary embodiment.

FIG. 10D is another employee screening procedure verification view the employer graphical user interface according to an exemplary embodiment.

FIG. 10E is another employee screening procedure verification view the employer graphical user interface according to an exemplary embodiment.

FIG. 10F is another employee screening procedure verification view the employer graphical user interface according to an exemplary embodiment.

FIG. 10G is another employee screening procedure verification view the employer graphical user interface according to an exemplary embodiment.

FIG. 10H is another employee screening procedure verification view the employer graphical user interface according to an exemplary embodiment.

FIG. 10I is another employee screening procedure verification view the employer graphical user interface according to an exemplary embodiment.

FIG. 10J is another employee screening procedure verification view the employer graphical user interface according to an exemplary embodiment.

FIG. 11 is a flowchart illustrating a process for quantifying the risk of harm or loss posed by an employer according to an exemplary embodiment.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

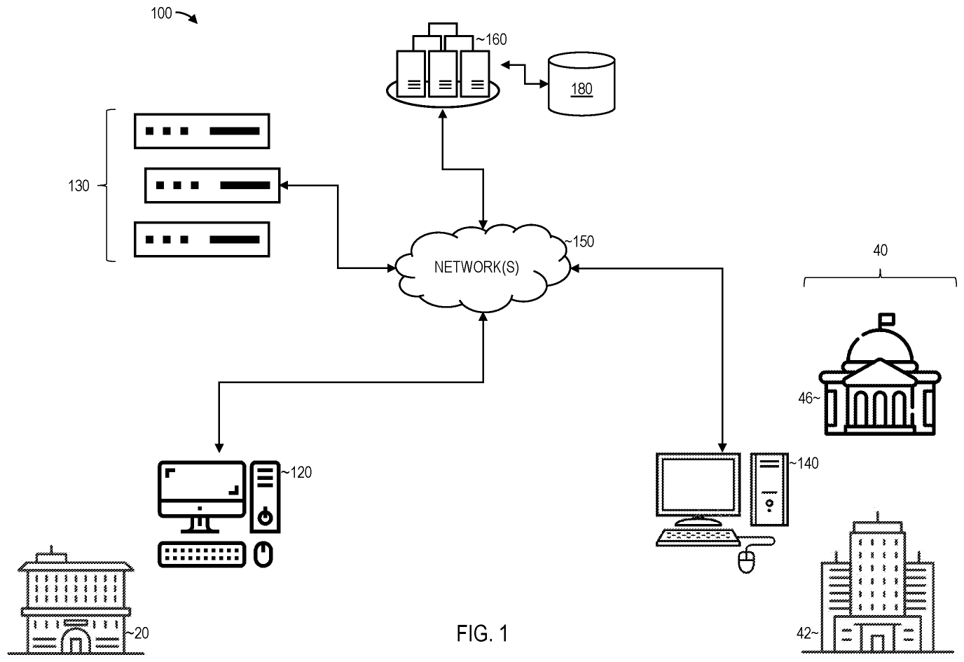

FIG. 1 is a diagram of an architecture 100 of a risk quantification system according to an exemplary embodiment.

As shown in FIG. 1, the architecture 100 includes a server 160 and non-transitory computer-readable storage media 180. The server 160 communicates with an assessor computer 140 at an assessor 40 and an employer computer 120 at an employer 20 via one or more networks 150. An assessor 40 may be, for example, an insurer 42, a government agency 44, a third-party risk quantification service, an individual, etc.

The server 160 may be any hardware computing device having one or more hardware computer processors that perform the functions described herein. For example, the server 160 may be a web server that provides a graphical user interface to receive information from the assessor computer 140 and the employer computer 120 via the internet. As described below, the server 160 may also receive information from publicly accessible third-party information sources 130. For example, the server 160 may scrape the web for publicly accessible information regarding the employer 20.

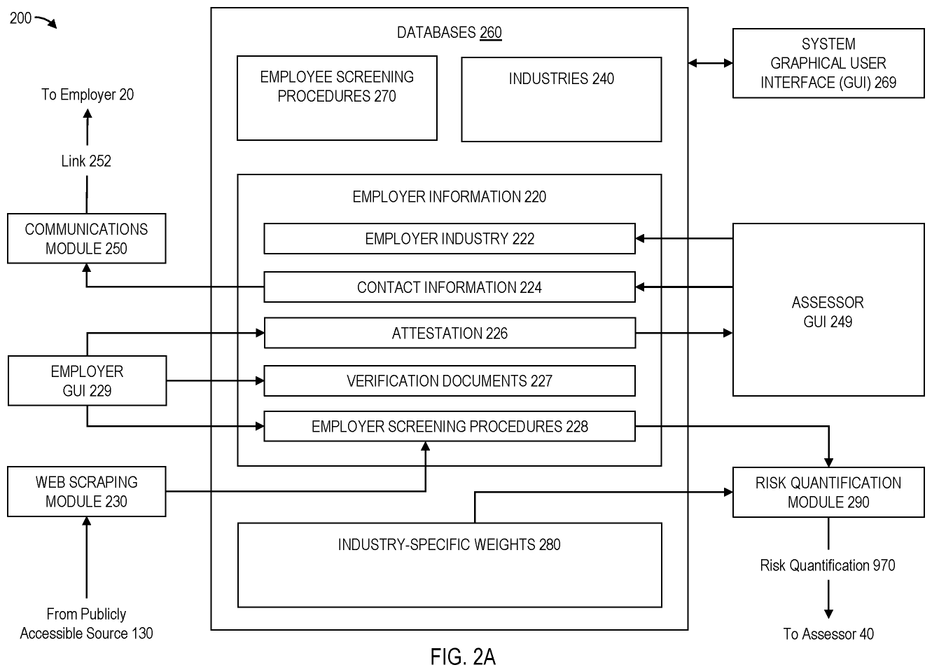

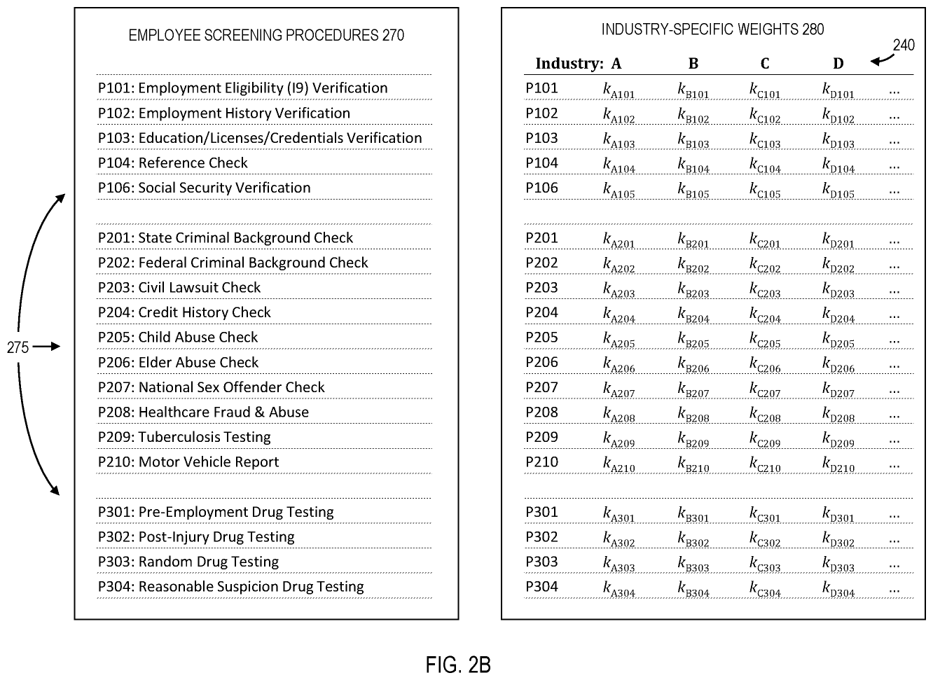

FIG. 2A is a block diagram illustrating the risk quantification system 200 according to an exemplary embodiment. As shown in FIG. 2A, the risk quantification system 200 includes one or more databases 260 (stored, for example, by the computer-readable storage media 180) and a system graphical user interface (GUI) 269 (provided by the server 160 and accessible, for example, via the one or more networks 150).

As described in detail below, the risk quantification system 200 stores a number of employee screening procedures 270, a number of industries 240, and, for each industry 240, industry-specific weights 280 indicative of the relative effectiveness of each of the employee screening procedures 270 for reducing the risk of harm or loss posed by an employer 20 in that industry 240. Those employee screening procedures 270 are derived from literature identifying the best practices for screening employees in each industry 240 and identifying the relative effectiveness of each employee screening procedure 270 for reducing the risk of harm caused by—and loss to—an organization in each industry 240.

FIG. 2B illustrates the employee screening procedures 270 and industry-specific weights 280 in greater detail according to an exemplary embodiment.

As shown in FIG. 2B, the risk quantification system 200 stores a number of pre-identified employee screening procedures 270. In some embodiments, those employee screening procedures 270 are grouped in a number of categories 275. For each of a number of industries 240, the risk quantification system 200 stores an industry-specific weight 280 associated with each employee screening procedure 270 indicative of the relative effectiveness of each employee screening procedure 270 to reduce the risk of future loss to an organization in that specific industry 240.

In the example shown in FIG. 2B, for instance, one of the pre-stored employee screening procedures 270 may be employment eligibility (19) verification (identified as procedure P101). For each industry 240 (identified as industries A, B, C, D, etc.), the risk quantification system 200 stores an industry-specific weight 280 indicative of the relative effectiveness of procedure P101 to reduce the risk of future loss to an organization in that specific industry 240. In industry A, for instance, industry-specific weight 280 for procedure P101 is identified as k_{A101}.

The risk quantification system 200 may store industry-specific weights 280 for any number of industries 240. For example, the risk quantification system 200 may store industry-specific weights 280 for industries including information, manufacturing, mining, professional, retail, service, transportation, utilities, volunteer, etc.

Referring back to FIG. 2A, the employee screening procedures 270 and industry-specific weights 280 stored in the one or more databases 260 may be input via the system GUI 269. The system risk quantification 200 provides functionality, via the system GUI 269, to update the list of pre-stores employee screening procedures 270 and/or the industry-specific weights 280 in response to changes in the consensus for what is considered best practices in each industry.

The risk quantification system 200 may also include an assessor GUI 249 for receiving information from the assessor 40. The assessor GUI 249 may, for example, be provided by the server 160 and accessible via the assessor computer 140. The risk quantification system 200 may also include an employer GUI 229. The employer GUI 229 may, for example, be provided by the server 160 and accessible via the employer computer 120.

The risk quantification system 200 stores employer information 220 regarding each of a number of employers 20. The risk quantification system 200 also include a risk quantification module 290 that quantifies the risk of future harm or loss posed by each employer 20 based on the employer information 220.

In some instances, an assessor 40 (e.g., an insurer 42) may request that an employer 20 provide employer information 220 so as to quantify the employer's risk of causing future harm and experiencing future loss. Accordingly, the risk quantification system 200 may provide functionality, via the assessor GUI 249, for the assessor 40 to specify contact information 224 for the employer 20. In those embodiments, the risk quantification system 200 may include a communications module 250 that generates a link 252 providing the employer 20 with access to the risk quantification system 200 via the employer GUI 229 and outputs that link 252 for transmittal to the employer 20 via the networks 150. For example, the communications module 250 may generate a link 252 to the employer GUI 229 and email that link 252 to an email address specified in the contact information 224 of the employer 20. In other instances, an employer 20 may use the risk quantification system 200 to quantify its own risk of future harm or loss. For example, an employer 20 may be required to do so in order to contract with a government agency

The employer information 220 for each employer 20 may also include the industry 240 of the employer 20 (hereinafter referred to as the employer industry 222). The employer industry 222 may be specified by the assessor 40 via the assessor GUI 249 or by the employer 20 via the employer GUI 229. The employer information 220 for each employer 20 may also include the employee screen procedures 270 performed by the employer 20 (referred to herein as employer screening procedures 228). The employer screening procedures 228 may be specified by the employer 20 via the employer GUI 229. The employer information 220 for each employer 20 may also include an attestation 226 and/or verification documents 227 received from the employer 20 via the employer GUI 229.

The risk quantification module 290 quantifies the risk of future harm or loss posed by each employer 20—and generates a risk quantification 970 indicative of that future harm or loss—based on the employer screening procedures 228 specified by the employer 20, the employer industry 222, and the industry specific weights 280 for the employer industry 222. The risk quantification 970 may be a numerical rating, a letter grade (e.g., an “A” through “D” or “F” rating), a star rating (e.g., 0 to 5 stars), etc. For example, the risk quantification 970 may be a numerical rating generated by summing the industry-specific weights 280 (for the employer industry 222) of each employer screening procedures 228 performed by the employer 20. In another example, the risk quantification 970 may be a letter grade or star rating generated by storing thresholds for each letter grade or star rating and comparing the numerical rating (generated by summing the industry-specific weights 280, for the employer industry 222, of each employer screening procedures 228 performed by the employer 20) to the thresholds for each letter grade or star rating.

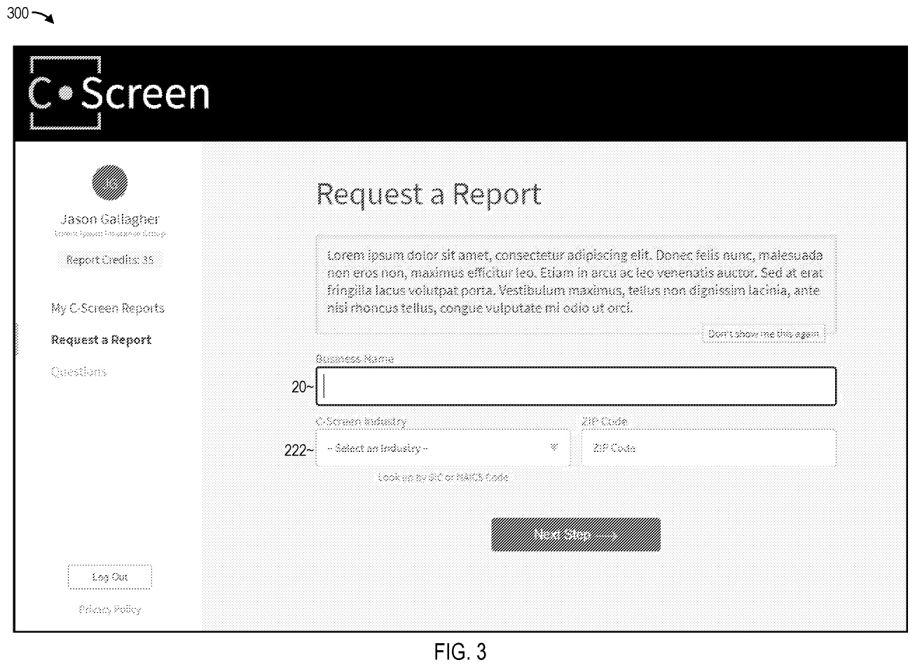

FIG. 3 is a risk quantification request view 300 generated and output by the risk quantification system 200 according to an exemplary embodiment. As shown in FIG. 3, the risk quantification system 200 provides functionality to identify an employer 20 and the employer industry 222. As briefly mentioned above, the risk quantification 970 for an employer 20 may be requested by an assessor 40 or the employer 20. Accordingly, the risk quantification request view 300 may be output via the assessor GUI 249 for the assessor 40 to identify the employer 20 and the employer industry 222. Alternatively, the risk quantification request view 300 may be output via the employer GUI 229 for the employer 20 to identify both the name of the employer 20 and the employer industry 222.

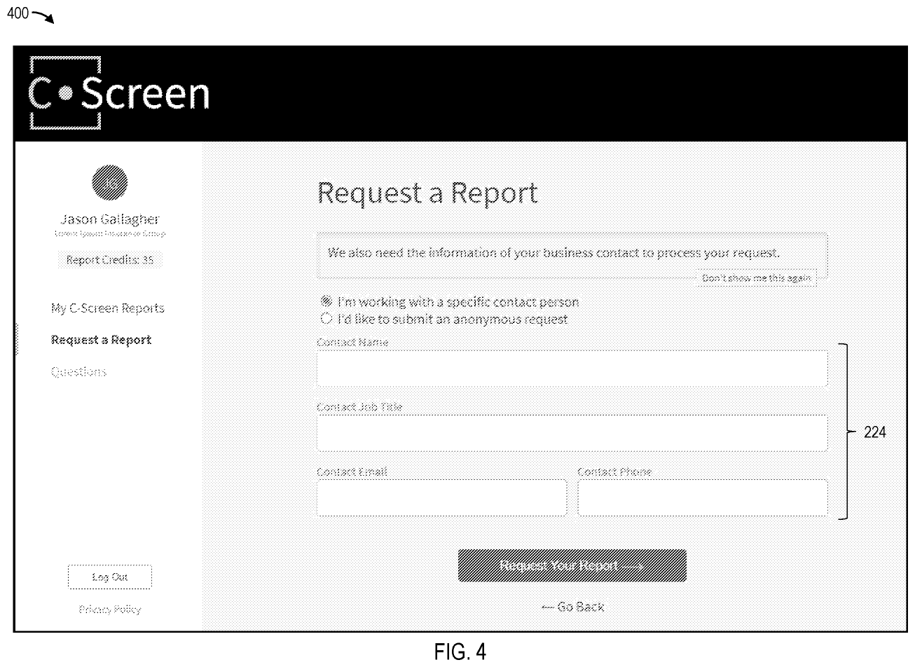

FIG. 4 is an employer contact information view 400 of the assessor GUI 249 generated and output by the risk quantification system 200 according to an exemplary embodiment. As shown in FIG. 4, the risk quantification system 200 provides functionality for an assessor 40 to identify contact information 224 for the employer 20 and request that the employer 20 provide employer information 220. In those instances, the communications module 250 generates a link 252 providing the employer 20 with access to the risk quantification system 200 via the employer GUI 229 and outputs that link 252 for transmittal to the employer 20 via the networks 150. Accordingly, the assessor 40 can obtain a risk quantification 970 quantifying the risk of future harm or loss posed by the employer 20.

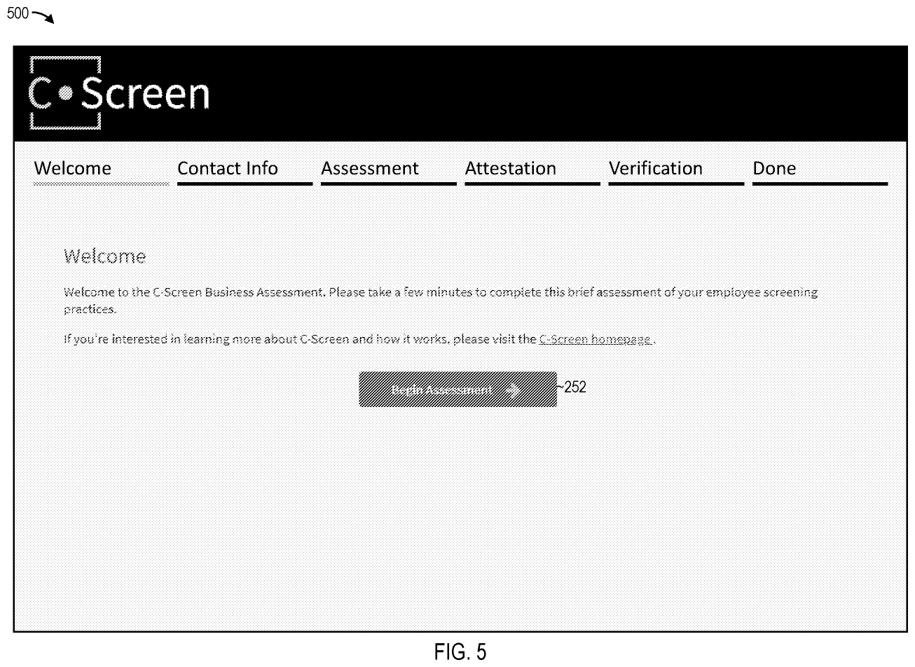

FIG. 5 is a welcome view 500 of the employer GUI 229 generated and output by the risk quantification system 200 according to an exemplary embodiment. As shown in FIG. 5, the risk quantification system 200 provides functionality for the employer 20 to provide employer information 220 via the risk quantification system 200.

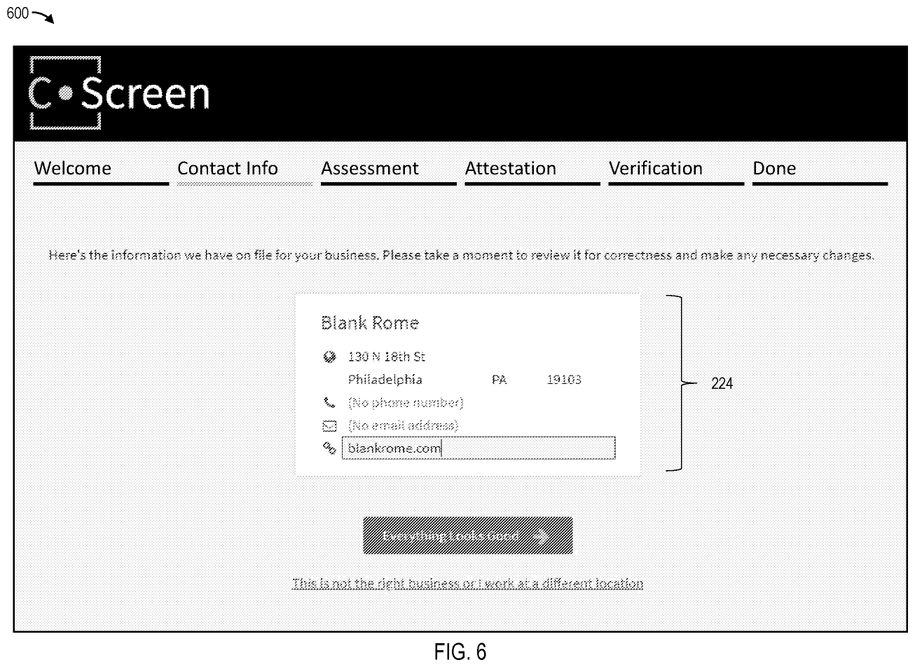

FIG. 6 is a contact information view 600 of the employer GUI 229 generated and output by the risk quantification system 200 according to an exemplary embodiment. As shown in FIG. 6, the risk quantification system 200 provides functionality for the employer 20 to verify or update the contact information 224 of the employer 20.

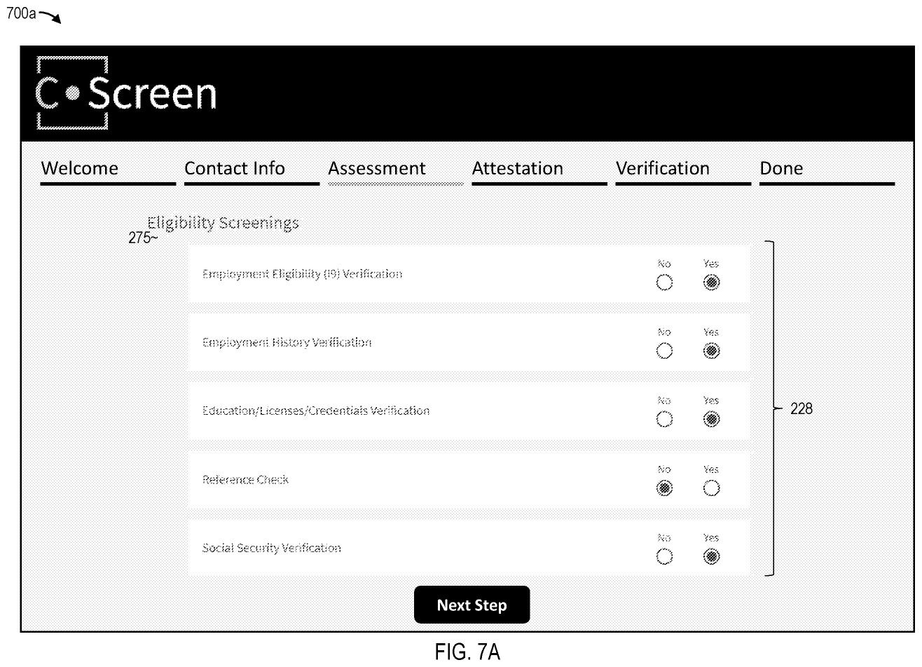

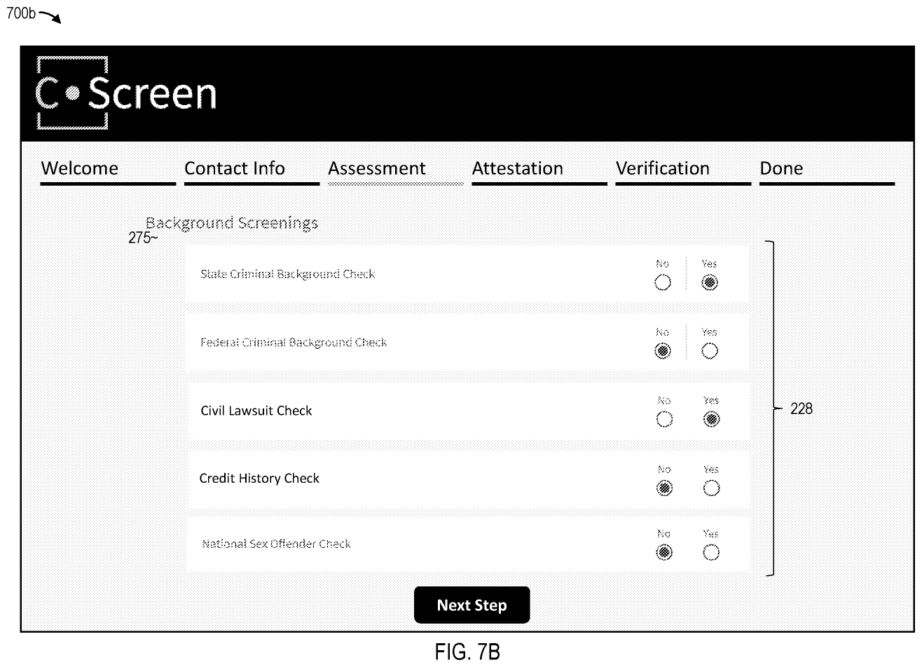

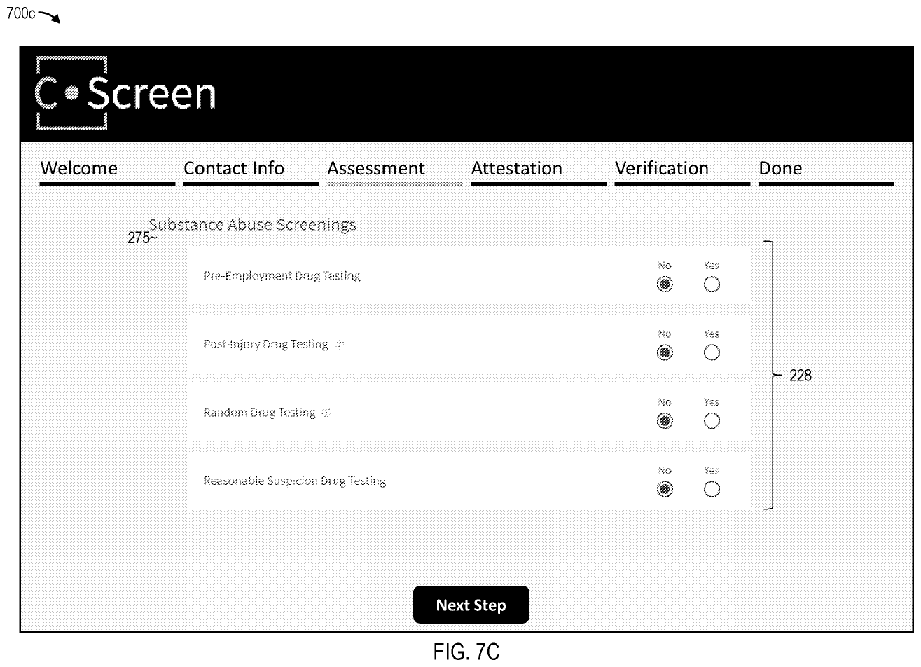

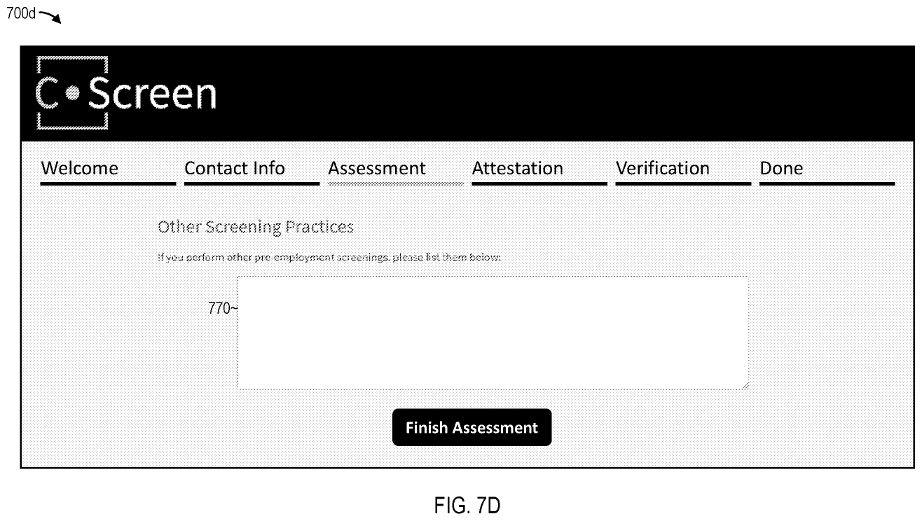

FIGS. 7A through 7D are assessment views 700a, 700b, 700c, and 700d of the employer GUI 229 generated and output by the risk quantification system 200 according to an exemplary embodiment.

As shown in FIGS. 7A through 7D, the risk quantification system 200 provides functionality for the employer to specify which of the employee screen procedures 270 are performed by the employer 20 (referred to herein as employer screening procedures 228). As mentioned above with reference to FIG. 2A, the employee screen procedures 270 may be pre-identified using the system GUI 269 and stored in the one or more databases 260. Accordingly, the risk quantification system 200 may provide functionality for the employer to identify each of the employer screening procedures 228 by answering a series of yes or no questions each listing one of the pre-identified employee screen procedures 270. Those pre-identified employee screen procedures 270 may be grouped in any number of categories 275. Furthermore, as shown in FIG. 7D, the risk quantification system 200 may provide functionality 770 for the employer 20 to specific any additional employee screen procedures that were not pre-identified by the risk quantification system 200.

As briefly mentioned above, the server 160 may date stamp the employer information 220 provided by the employer 20 via the employer GUI 269. For instance, the server 160 may store the employer screening procedures 228 specified by the employer 20 and the date that the employer 20 specified those employer screening procedures 228.

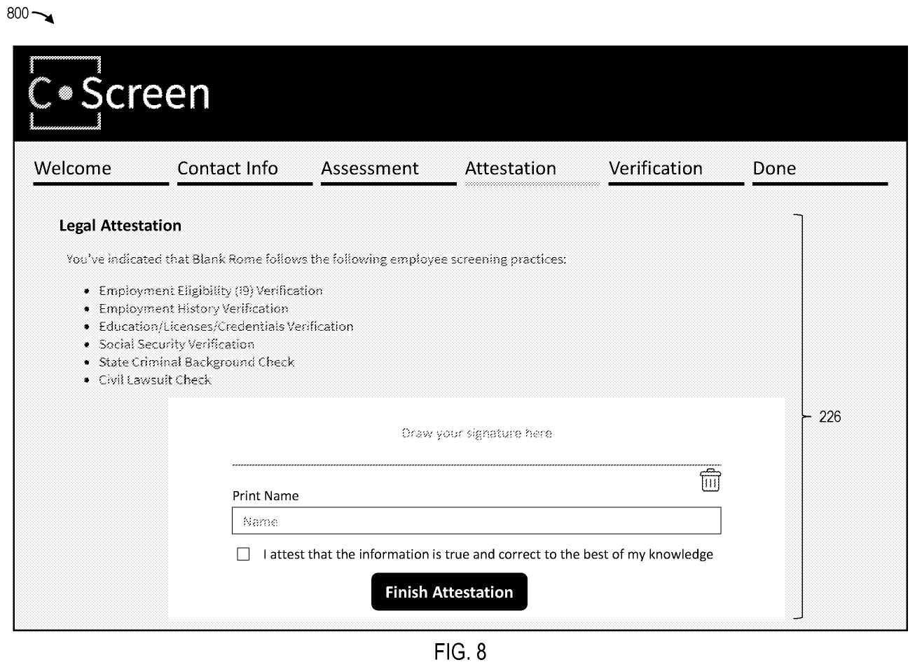

FIG. 8 is an attestation view 800 of the employer GUI 229 generated and output by the risk quantification system 200 according to an exemplary embodiment. As shown in FIG. 8, the risk quantification system 200 may be configured to receive an attestation 226 from the employer 20 that the employer information 220 provided by the employer 20 via the risk quantification system 200 is true and correct. In some embodiments, the risk quantification system 200 may require an attestation 226 from the employer 20 before providing the risk quantification 970 described below.

Referring back to FIG. 2A, the employer information 220 may include a date stamp indicative of the date the employer information 220 was received. In those embodiments, the risk quantification system 200 may provide functionality for the assessor 40 to review the employer information 220 and ensure that employer information 220 stored by the risk quantification system 200 is current. In the event that assessor 40 decides that the employer information 220 for an employer 20 is outdated, the communications module 250 provides functionality for the assessor 40 to contact the employer 20 and the employer GUI 229 provides functionality for the employer 20 to revise the employer information 220 as necessary and re-attest that the employer information 220 stored by the risk quantification system 200 is accurate and current.

The risk quantification system 200 may also include a web scraping module 230 that identifies the employer screening procedures 228 of an employer 20 by scraping information from one or more publicly accessible sources 130. For example, the web scraping module 230 may identify job listings posted by the employer 20 (e.g., on the website of the employer 20 or a job listings website) or publicly accessible information regarding employers 20 (e.g., websites such as Indeed, Glassdoor, etc.). The web scraping module 230 may be configured to parse the job listing or other information and identify any of the employee screening procedures 270 stored in the one or more databases 260. As such, the web scraping module 230 may identify information indicating that an employer 20 is not performing one or more of the employee screening procedures 270 stored in the one or more databases 260 (including, for example, employee screening procedures 270 specified by the employer 20 while inputting the employer screening procedures 228).

To perform those functions, the web scraping module 230 may scrape certain pre-identified sources 130 (or the broader web) for job listings and other information regarding any of the employers 20 with employer information 220 in the one or more databases 260. The web scraping module 230 may employ various techniques to identify job listings, the employers 20 advertising open positions, and the employee screening procedures 270 performed to screen candidates for those open positions. For example, the web scraping module 230 may search for pre-determined keywords indicating that the pre-identified source 130 or web page is a job listing, the names and/or acronyms of the employers 20 with employer information 220 in the one or more databases 260, and pre-determined keywords indicative of the employee screening procedures 270 stored by the risk quantification system 200. Additionally, or alternatively, the web scraping module 230 may parse each job listing or other information source using a machine learning algorithm (e.g., a neural network) trained on a training dataset of job listings and/or other information sources. The training dataset may include examples of job listings (or other information sources) that include information indicating that one or more of the employee screening procedures 270 stored in the database(s) 260 are required. The training dataset may also include other examples of job listings (or other information sources) that do not include information indicating that any of those employee screening procedures 270 will be performed. Each example in the training dataset may be labeled to indicate the specific employee screening procedures 270 indicated (and not indicated) in that example. Therefore, by training on the training dataset, the machine learning module is trained to parse publicly accessible sources 130 and determine employee screening procedures 270 performed and not performed by employers 20.

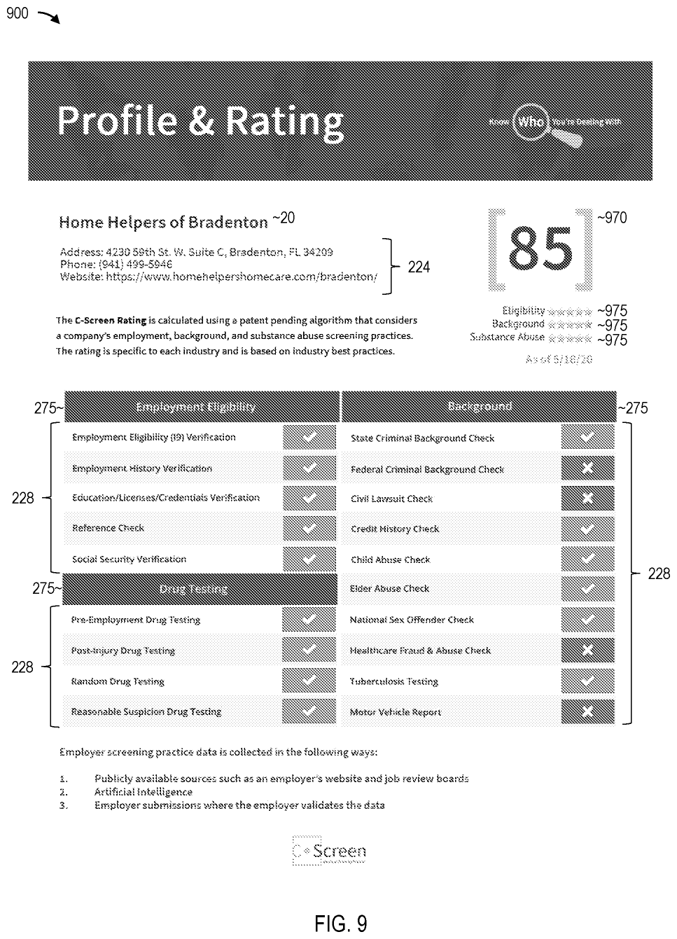

FIG. 9 is an example report 900 quantifying the risk of harm or loss posed by an employer 20 generated by the risk quantification system 200 according to an exemplary embodiment.

As shown in FIG. 9, the report 900 includes a risk quantification 970. Additionally, the report 900 may also include the employer screening procedures 228 specified by the employer 20 (and the employee screening procedures 270 that the employer 20 does not perform). Accordingly, the risk quantification system 200 enables the assessor 40 to obtain an objective, rules-based risk quantification 970 regarding the employer 20. Furthermore, by specifying the employee screening procedures 270 that the employer 20 does not perform, the report 900 provides the employer 20 with concrete steps they can take to reduce their risk of loss and, by extension, reduce their insurance costs.

In some embodiments, the report 900 may group the employee screening procedures 270 into the pre-determined categories 275 described above. In some of those embodiments, the report 900 may also include a sub-quantification 975 of the employer screening procedures 228 performed by the employer 20 in each category 275. Those sub-quantification 975 may be generated by the risk quantification module 290 by taking the weighted sum of each employer screening procedures 228 in each category 275 as weighted by the industry specific weight 280 of each employee screening procedure 270 for the industry employer 222. As with the risk quantification 970, the sub-quantifications 975 may be numeric, a letter grade, a star rating, etc.

By providing the sub-quantifications 975 for each category 275, the report 900 indicates the specific, objective information used by the risk quantification system 200 to quantify the risk of harm or loss posed by the employer 20. The employer 20 and the assessor 40 are then provided with additional information to better understand the risk posed by the employer 20. Furthermore, the employer 20 is given more information for why the risk quantification system 200 quantifies their risk and the concrete steps they can take to reduce their risk of loss and, by extension, reduce their insurance costs and increase their ability to contract with government agencies 44 and individual consumers.

In some embodiments, the risk quantification system 200 also provides functionality for the employer 20 to provide verification documents 227 verifying that the employer 20 performs the employer screening procedures 228 identified by the employer 20 above.

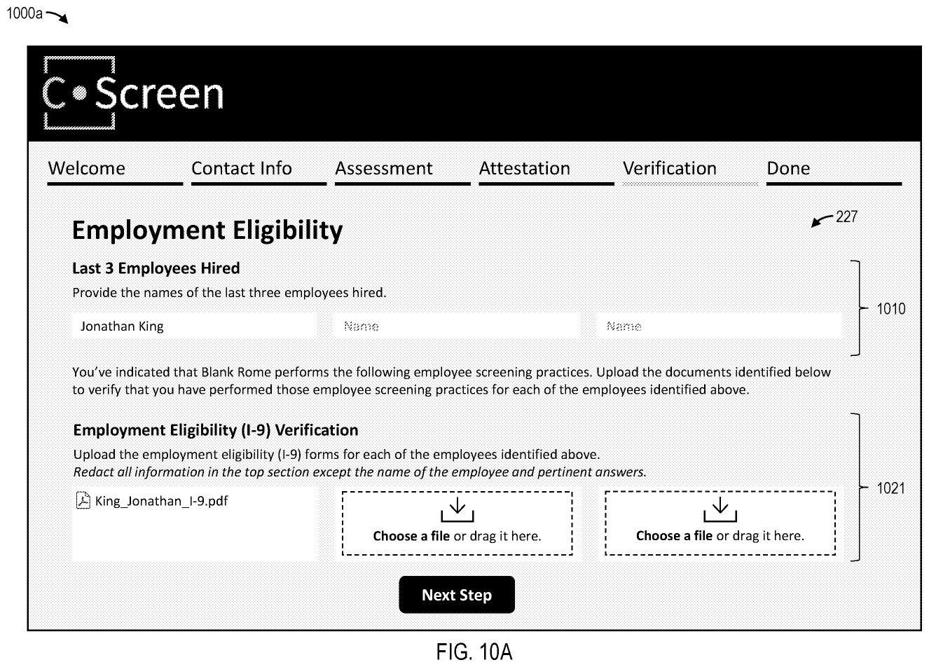

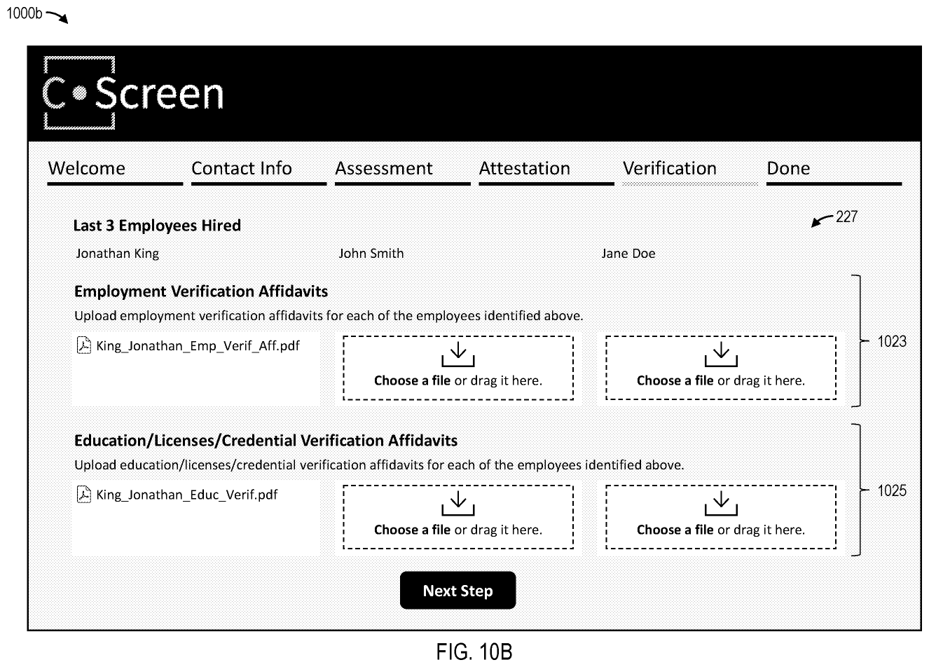

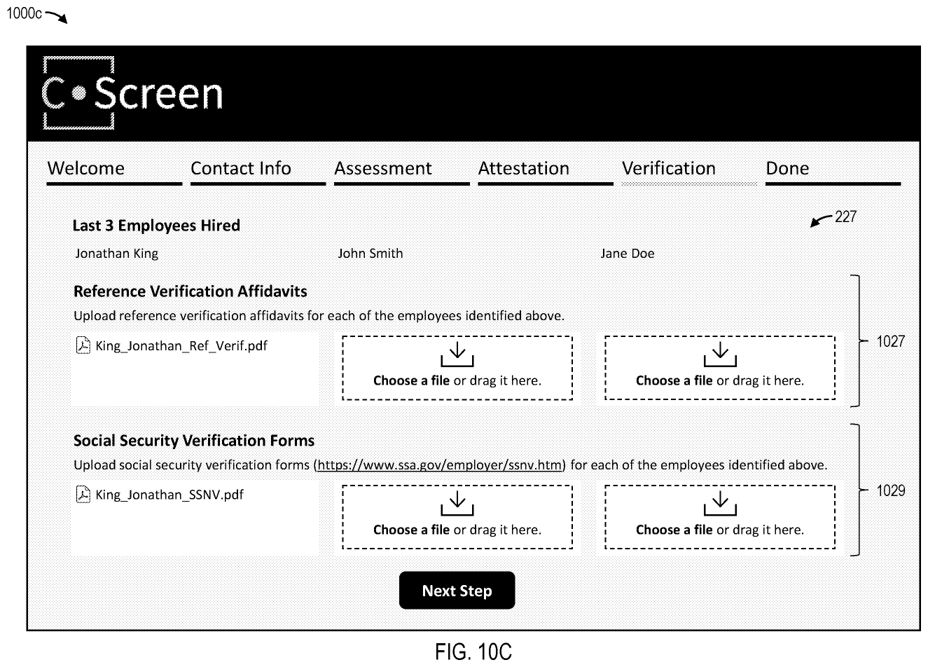

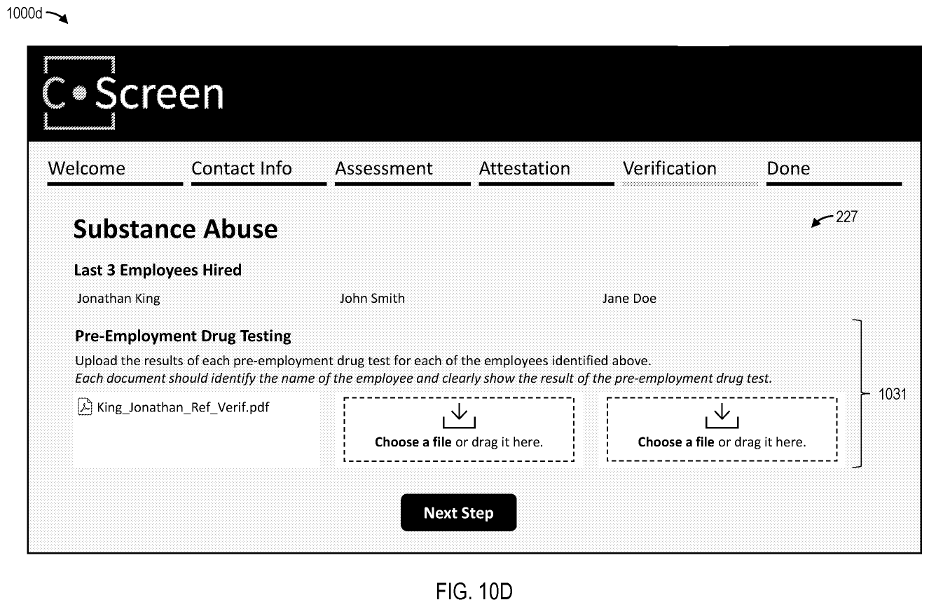

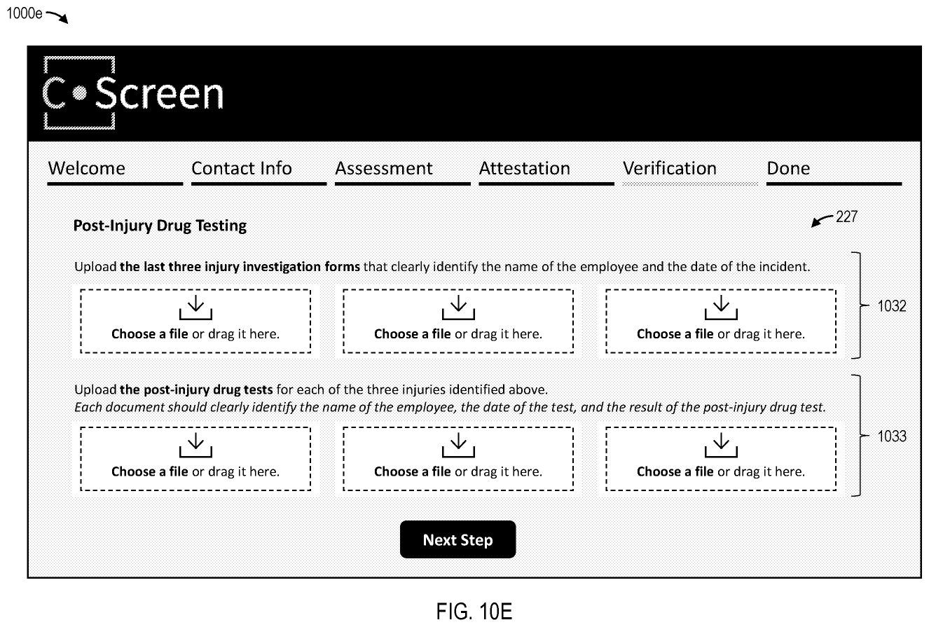

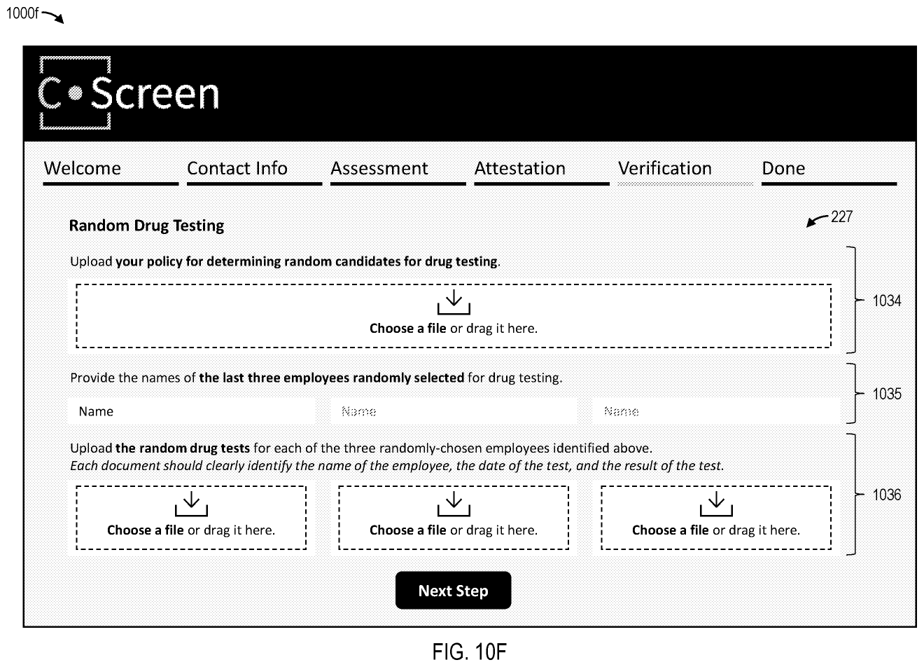

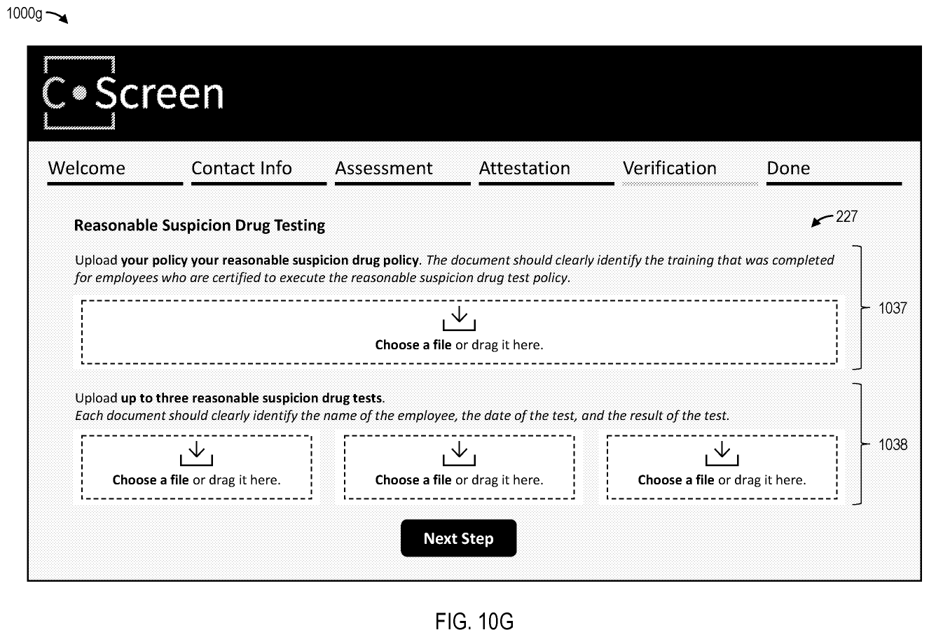

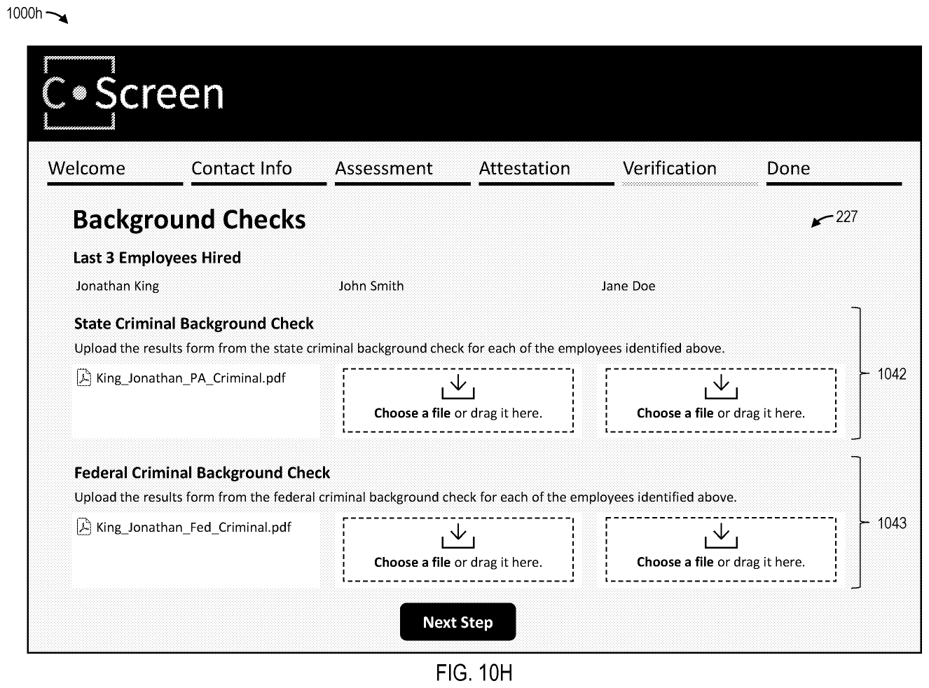

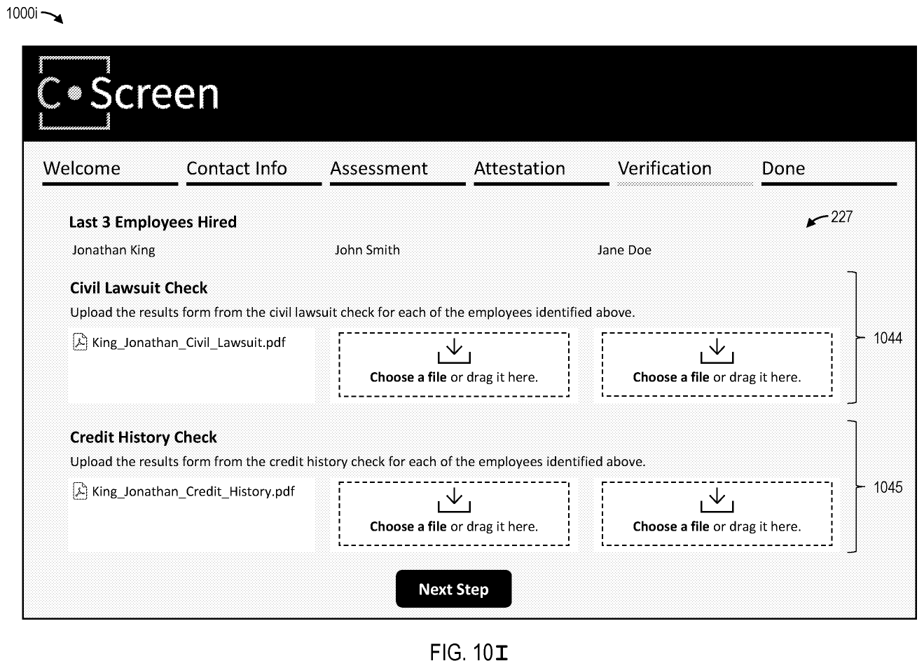

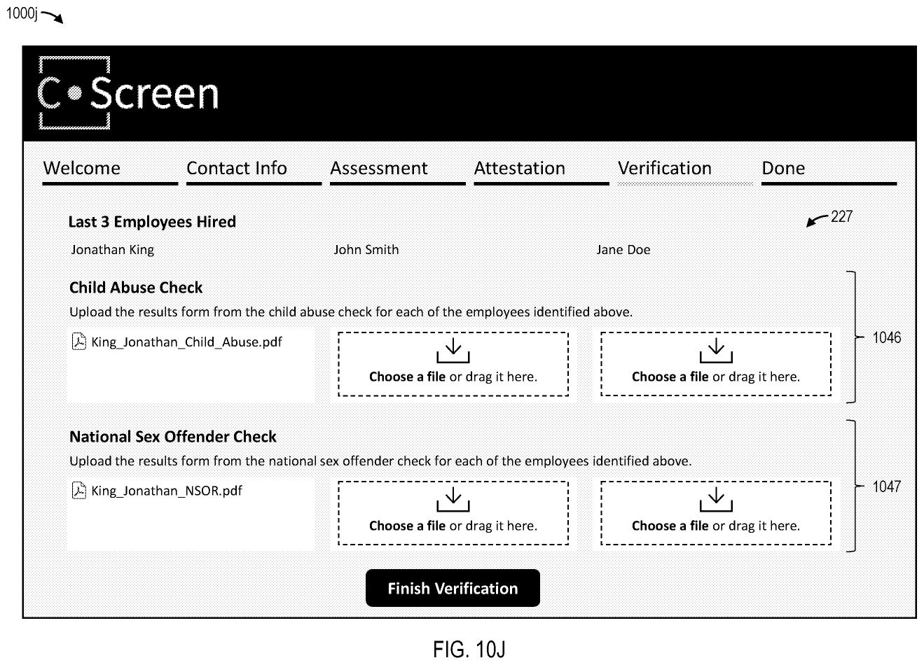

FIGS. 10A through 10J are employee screening procedure verification views 1000a through 1000j of the employer GUI 229 generated and output by the risk quantification system 200 according to an exemplary embodiment. In the embodiments of FIGS. 10A through 10J, for example, the risk quantification system 200 may provide functionality for the employer to provide verification documents 227 verifying that employer 20 has performed employment eligibility screening, pre-employment drug testing, and background checks on the last three employees hired; post-injury drug testing after the last three workplace injuries; random drug testing on three randomly-selected employees; and reasonable suspicion drug testing on up to three employees reasonably suspected of drug use.

In the embodiment of FIG. 10A, the employee screening procedure verification view 1000a provides functionality 1010 for the employer 20 to identify the last three employees hired and functionality 1021 for the employer 20 to provide the employment eligibility (I-9) verification forms for each of the last three employees hired.

In the embodiment of FIG. 10B, the employee screening procedure verification view 1000b provides functionality 1023 for the employer 20 to provide employment verification affidavits for the last three employees hired and functionality 1025 for the employer 20 to provide education/licenses/credential verification affidavits for the last three employees hired.

In the embodiment of FIG. 10C, the employee screening procedure verification view 1000c provides functionality 1027 for the employer 20 to provide reference verification affidavits for the last three employees hired and functionality 1029 for the employer 20 to provide social security verification forms for the last three employees hired.

In the embodiment of FIG. 10D, the employee screening procedure verification view 1000d provides functionality 1031 for the employer 20 to provide the results of the pre-employment drug tests for the last three employees hired.

In the embodiment of FIG. 10E, the employee screening procedure verification view 1000e provides functionality 1032 for the employer 20 to provide the injury investigation forms from the last three workplace injuries and functionality 1033 for the employer 20 to provide the results from the post-injury drug tests performed after each of the last three workplace injuries.

In the embodiment of FIG. 10F, the employee screening procedure verification view 1000f provides functionality 1034 for the employer 20 to provide its policy for determining random candidates for drug testing, functionality 1035 to identify the last three employees randomly selected for drug testing, and functionality 1036 for the employer 20 to provide the results of the drug tests for each of the last three employees randomly selected for drug testing.

In the embodiment of FIG. 10G, the employee screening procedure verification view 1000g provides functionality 1037 for the employer 20 to provide its reasonable suspicion drug policy (indicating the training completed by employees who are certified to execute the reasonably suspicion drug testing) and functionality 1038 for the employer 20 to provide the results of at least three drug tests given to employees reasonably suspected of drug use.

In the embodiment of FIG. 10H, the employee screening procedure verification view 1000h provides functionality 1042 for the employer 20 to provide the results of the state criminal background check performed on the last three employees hired and functionality 1043 for the employer 20 to provide the results of the federal criminal background check performed on the last three employees hired.

In the embodiment of FIG. 10I, the employee screening procedure verification view 1000i provides functionality 1044 for the employer 20 to provide the results of the civil lawsuit check performed on the last three employees hired and functionality 1045 for the employer 20 to provide the results of the credit history check performed on the last three employees hired.

In the embodiment of FIG. 10J, the employee screening procedure verification view 1000j provides functionality 1046 for the employer 20 to provide the results of the child abuse check performed on the last three employees hired and functionality 1047 for the employer 20 to provide the results of the national sex offender check performed on the last three employees hired.

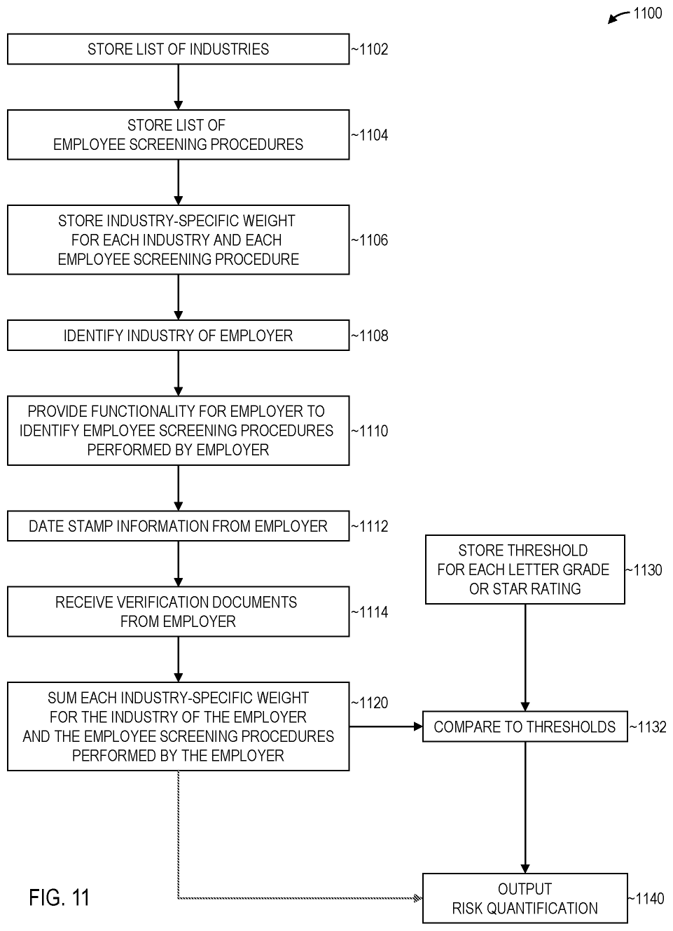

FIG. 11 is a flowchart illustrating a process 1100 for quantifying the risk of harm or loss posed by an employer 20 according to an exemplary embodiment. As described above, the process 1100 may be performed by the risk quantification system 200 (for example, by a hardware processing unit of the server 160). As one of ordinary skill in the art will recognize, some of the processing steps may not be included in all embodiments and the processing steps shown in FIG. 11 and described below do not necessarily have to be performed in the order shown in FIG. 11 and presented below.

A list of industries 240 is stored (e.g., in the computer readable storage media 180) in step 1102. A list of employee screening procedures 270 is stored (e.g., in the computer readable storage media 180) in step 1104. An industry-specific weight 280 is stored (e.g., in the computer readable storage media 180) for each industry 240 and each employee screening procedure 270 in step 1106.

In step 1108, the industry of an employer 20 (referred to as the employer industry 222) is selected from among the industries 240 stored in step 1102. For example, the employer industry 222 may be specified by the employer 20 via the employer GUI 229 or by an assessor 40 via the assessor GUI 249 as described above with reference to FIG. 3.

In step 1110, the employer 20 is provided with functionality to specify the employer screening procedures 228 performed by the employer 20 from among the employee screening procedures 270 stored in step 1104, for example over a computer network 130 via the employer GUI 229 as described above with reference to FIGS. 7A through 7D. In some embodiments, the employer information 220 provided by the employer 20 is date stamped in step 1112.

Verification documents 227, verifying that the employer 20 performs the employer screening procedures 228, are received from the employer 20 in step 1114. As described above with reference to FIGS. 10A through 10J, for example, in some embodiments the risk quantification system 200 provides functionality for the employer 20 to upload the verification documents 227 over the one or more computer networks 130 via the employer GUI 229.

In step 1120, the risk of harm or loss posed by the employer 20 is quantified by summing the industry-specific weights 280, for the employer industry 222, for each employer screening procedures 228 performed by the employer 20. A risk quantification 970 indicative of the risk of harm or loss by the employer 20 is output (e.g., to the employer 20 or an assessor 40) in step 1140. In some embodiments, the risk quantification 970 is a numerical metric (e.g., the sum calculated in step 1120). In other embodiments, the risk quantification 970 is a letter grade or a star rating. In those embodiments, a threshold for each letter grade or star rating may be stored in step 1130 and the letter grade or star rating may be identified by comparing the numerical sum calculated in step 1120 to the thresholds stored in step 1130.

### Benefits of the Risk Quantification System 200

As described above, the risk quantification system 200 eliminates the need for insurers, government agencies, and individual consumers to subjectively assess an organization's risk of causing personal harm and experiencing financial loss. Instead, the risk quantification system 200 quantifies the risk posed by an employer 20 by identifying the employee screening procedures 270 performed by the employer 20 (employer screening procedures 228) and applying an objective, rules-based process. Because the relative effectiveness of each employee screening procedure 270 (to reduce the risk of harm caused by an organization and the risk of future loss to that organization) varies from industry 240 to industry 240, the risk quantification system 200 applies industry-specific weights 280 (derived from literature articulating best practices in each industry 240) indicative of the relative effectiveness of each employee screening procedure 270 to reduce the risk of harm or loss posed by organizations in the industry 240 of the employer 20 (the employer industry 222).

Rather than relying on human assessors 40 (who may come away with an inaccurate understanding of the employee screening procedures 270 that an employer 20 actually performs), the risk quantification system 200 gathers employer information 220 more efficiently by including an employer GUI 229 that provides functionality for the employer 20 to specify the employer screening procedures 228 performed by the employer 20 via a computer network 130. The risk quantification system 200 also enables the employer 20 to quickly and easily provide verification documents 227 verifying that the employer 20 performs the employer screening procedures 228. In some embodiments, the risk quantification system 200 provides those verification documents 227 to an assessor 40 (e.g., an insurer 42, a third-party risk quantification service, etc.). Accordingly, the risk quantification system 200 enables the assessor 40 to quickly and easily obtain the verification documents 227 necessary to verify that the employer 20 performs the employer screening procedures 228 and, by extension, the risk quantification 970 generated by the risk quantification system 200 for the employer 20 is accurate.

Because screening employees reduces their risk of future loss and, by extension, the cost of their insurance and the likelihood of contracting with government agencies and individual consumers, employers 20 are incentivized to identify all of the employer screening procedures 228 they perform (and in some instances may even be incentivized to perform additional employee screening procedures 270 to further reduce their risk quantification 970). In the event that the employer 20 fails to perform the identified employer screening procedures 228 and suffers a loss, the risk quantification system 200 enables an insurer 42 to seek remedies that may not have been previously available to the insurer 42 because the risk quantification system 200 receives that employer information 220 from the employer 20 (and an attestation 226 that the information is correct) rather than relying on an underwriter of the insurer 42.

Finally, by date stamping the employer information 220 received from the employer 20, the system provides functionality for the assessor 40 to ensure that the employer information 220 received from the employer 20 is timely. Meanwhile, the risk quantification system 200 provides a platform to contact the employer 20 and functionality for the employer 20 to revise the employer information 220 they provided as necessary and re-attest that the employer information 220 provided is accurate and current.

While a preferred embodiment of the risk quantification system 200 has been described above, those skilled in the art who have reviewed the present disclosure will readily appreciate that other embodiments can be realized within the scope of the invention. Accordingly, the present invention should be construed as limited only by any appended claims.

1. A system for quantifying the risk of harm or loss posed by an employer, the system comprising:
non-transitory computer readable storage media that stores:
a plurality of industries;
a plurality of employee screening procedures; and
an industry-specific weight for each of the plurality of employee screening procedures and each of a plurality of industries, wherein each industry-specific weight is indicative of a relative importance of performing the employee screening procedure to reduce the risk of harm or loss posed by an organization in the industry;
an employer graphical user interface that provides functionality, via a computer network, for an employer to specify the employee screening procedures performed by the employer; and
a hardware processing unit that:
receives verification documents from the employer, verifying that the employer performs the employee screening procedures specified by the employer;
identifies the industry of the employer; and
quantifies the risk of harm or loss posed by the employer by summing each of the industry-specific weights, for the industry of the employer, of the employee screening procedures performed by the employer.

2. The system of claim 1, wherein the stored employee screening procedures and the stored industry-specific weights are derived from literature articulating best practices in each of the plurality of industries and the relative effectiveness of each of employee screening procedure to reduce the risk of harm or loss posed by organizations in each of the plurality of industries.

3. The system of claim 1, wherein the hardware processing unit is further configured to generate a letter grade or star rating quantifying the risk of harm or loss posed by the employer by:
storing a threshold for each letter grade or star rating; and
selecting a letter grade or star rating quantifying the risk of harm or loss posed by the employer by comparing the sum of each of the industry-specific weights to the thresholds.

4. The system of claim 1, wherein the employer graphical user interface provides functionality for the employer to upload the verification documents via the computer network.

5. The system of claim 1, wherein the hardware processing unit outputs a risk quantification quantifying the risk of harm or loss posed by the employer to an assessor.

6. The system of claim 5, wherein:
the employer graphical user interface provides functionality for the employer to attest that the employer performs the employee screening procedures identified by the employer; and
the system outputs an attestation to the assessor, executed by the employer, attesting that the employer performs the employee screening procedures identified by the employer.

7. The system of claim 5, wherein the system provides the verification documents, received from the employer, to the assessor.

8. The system of claim 5, wherein the hardware processing unit:
stores a date stamp indicative of the date when the employer specified, via the employee graphical user interface, the employee screening procedures performed by the employer;
outputs the date stamp to the assessor; and
provides functionality for the assessor to contact the employer to re-specify the employee screening procedures performed by the employer and/or re-attest that the employer performs the employee screening procedures identified by the employer.

9. The system of claim 1, further comprising a web scraping module that:
scrapes web pages;
identifies, in the scraped web pages, job listings posted by the employer advertising open positions; and
identifies, in the identified job listings, employee screening procedures performed by the employer.

10. The system of claim 9, wherein the web scraping module comprises a neural network trained on a dataset that includes job listings advertising open positions and indicating the employee screening procedures to be performed to screen candidates for those open positions.

11. A method of quantifying the risk of harm or loss posed by an employer, the method comprising:
storing a list of industries;
storing a list of employee screening procedures;
storing, for each employee screening procedure and each of the industries, an industry-specific weight indicative of a relative importance of performing the employee screening procedure to reduce the risk of harm or loss posed by an organization in the industry;
providing an employer graphical user interface that provides functionality for an employer to specify, via a computer network, the employee screening procedures performed by the employer;
receiving verification documents, from the employer, verifying that the employer performs the employee screening procedures specified by the employer;
identifying the industry of the employer; and
quantifying the risk of harm or loss posed by the employer by summing each of the industry-specific weights, for the industry of the employer, of the employee screening procedures performed by the employer.

12. The method of claim 11, wherein the stored list of employee screening procedures and the stored industry-specific weights are derived from literature articulating best practices in each of the industries and the relative effectiveness of each of employee screening procedure to reduce the risk of harm or loss posed by organizations in each of the industries.

13. The method of claim 11, further comprising:
generating a letter grade or star rating quantifying the risk of harm or loss posed by the employer by:
storing a threshold for each letter grade or star rating; and
selecting a letter grade or star rating quantifying the risk of harm or loss posed by the employer by comparing the sum of each of the industry-specific weights to the thresholds.

14. The method of claim 11, wherein the employer graphical user interface provides functionality for the employer to upload the verification documents via the computer network.

15. The method of claim 11, further comprising:
outputting a risk quantification quantifying the risk of harm or loss posed by the employer to an assessor.

16. The method of claim 15, wherein the employer graphical user interface provides functionality for the employer to attest that the employer performs the employee screening procedures identified by the employer, the method further comprising:
outputting an attestation to the assessor, executed by the employer, attesting that the employer performs the employee screening procedures identified by the employer.

17. The method of claim 15, further comprising:
outputting the verification documents, received from the employer, to the assessor.

18. The method of claim 15, further comprising:
storing a date stamp indicative of the date when the employer specified, via the employee graphical user interface, the employee screening procedures performed by the employer;
outputting the date stamp to the assessor; and
providing functionality for the assessor to contact the employer to re-specify the employee screening procedures performed by the employer and/or re-attest that the employer performs the employee screening procedures identified by the employer.

19. The system of claim 1, further comprising:
scraping web pages to identify job listings posted by the employer advertising open positions; and
identifying, in the identified job listings, employee screening procedures performed by the employer.

20. The method of claim 19, wherein the web pages are scraped by a neural network trained on a dataset that includes job listings advertising open positions and indicating the employee screening procedures to be performed to screen candidates for those open positions.
